(19) United States
(12) Patent Application Publication
(10) Pub. No.: US 2011/0035979 A1
(43) Pub. Date: Feb. 17, 2011

(54) MOTOR VEHICLE BEHIND-GLASS ADHESIVE LABEL

(76) Inventors: Arnd Friedrichs, Leipzig (DE); Thomas Wuttke, Leipzig (DE)

Correspondence Address: BACHMAN & LAPOINTE, P.C., 900 CHAPEL STREET, SUITE 1201, NEW HAVEN, CT, 06510, US

(21) Appl. No.: 12/775,928

(22) Filed: May 7, 2010

(30) Foreign Application Priority Data
Aug. 11, 2009 (DE) 202009010773.6

(51) Int. Cl. G09F 3/10; G06F 15/16; G06K 19/06

(52) U.S. Cl. 40/638; 235/494; 709/219

(57) ABSTRACT

A motor vehicle behind-glass adhesive label with printing having a multiplicity of items of information, which is applied onto a flexible carrier layer by means of laser, offset and/or digital printing, characterised in that the carrier layer is implemented as a single layer of a non-transparent polymer material and is designed so that it can adhere to a motor vehicle glass surface on its printed side and without any intermediate adhesive and/or adhesive material.

### BACKGROUND OF THE INVENTION

The present invention relates to a motor vehicle behind-glass adhesive label according to the preamble of the main claim.

A device of this kind is generally of known art from the prior art and is based on common practice in the USA and Canada (alternatively North America) and legally regulated requirements to identify motor vehicles that are for sale with legally designated information components. To be more precise the so-called Automobile Information Disclosure Act of 1958, also called the Monroney Act, regulates what information is to be provided on such a self-adhering price label of known art in order to display a motor vehicle in a manner conforming to legislation. To this end belong in terms of content, alongside items of information specific to the vehicle type such as price, engine specifications, and standard of fittings, other specific items of information such as environmental sustainability items, e.g. emissions output and similar, together with fuel consumption items.

Not least on account of the legal requirements this form of motor vehicle identification of known art is widely propagated and standardised, apart from details.

However, the use and actual application of this kind of behind-glass adhesive label, of known art from the prior art, also brings with it disadvantages that are in need of improvement, which in straightforward everyday use have a disruptive effect. Thus FIG. 5 clarifies the state-of-the-art structure of an adhesive label of known art, understood to be genus-defining: a multi-layer structure consisting of a first paper carrier layer 50, an adhesive layer 52 formed on top of the first paper layer, together with a second paper layer 54 formed on top of the adhesive layer, is provided by printing in a manner otherwise of known art, e.g. by means of a laser printer, with a printed layer 56 such that the layer arrangement shown in FIG. 5 is generated. To attach an adhesive label of this kind with the typical format 17 in×11 in, (431.8 mm×279.4 mm) provision is then made firstly for adhesion (as a behind-glass adhesive label behind a motor vehicle glass screen 22), in that a stamped-out edge section 62 of the paper layer 54 is removed in accordance with the direction of the arrow in FIG. 5. This exposes in the edge region the underlying adhesive layer 52, with which an operator can then attach the adhesive label to the interior of the screen (typically cleaned beforehand).

However, a procedure of this kind of known art is disadvantageous in many respects. Firstly the printing process is laborious and subject to errors, since it is not usual to print any blank masters; instead as a master the user encounters sets of documents already pre-printed, which he then supplements with specific information for the motor vehicle in question. In other words, the document set shown in FIG. 5 is fed through a printing arrangement at least twice, with the potential problems linked with this process of a paper jam, an adhesive layer that is becoming unusable or deteriorating, or similar. With modifications of the content of the first printing the pre-fabricated masters become unusable, and must be disposed of and newly pre-printed.

To this is added the problem that an adhesive label of the kind shown in FIG. 5 once it has been applied in practice cannot be removed without leaving residues. Residues of the adhesive edge layer 52 always remain in place, and these must then be removed by means of solvents in conjunction with removal tools or similar, either before the (sold) vehicle is delivered, or the adhesive label has to be removed intermittently, e.g. before a test run, or a new adhesive label has to be applied. Also procedure as determined by the system includes the principle of known art that an adhesive label once applied as a rule cannot be reused, because the adhesive layer is worn out or used up (the situation can in fact occur that as a result of intensive solar radiation and the thermal or UV radiation that accompanies it the adhesive layer 52, which just holds the adhesive label in the edge region, becomes ineffective and thus is no longer able to adhere the adhesive label to the screen.

As a result therefore the manufacturing and usage scenario for motor vehicle behind-glass adhesive labels of known art is disadvantageous and in need of improvement.

The object of the present invention is therefore to improve a the state-of-the-art motor vehicle behind-glass adhesive label of known art with regard to both a simple, cost-effective and easily manageable manufacturability, and also to improve its usage features in practice, both in terms of adhesion and also removal (and possible reuse).

### SUMMARY OF THE INVENTION

The object is achieved by means of the motor vehicle behind-glass adhesive label with printing having a multiplicity of items of information, which is applied onto a flexible carrier layer by means of laser, offset and/or digital printing, characterised in that the carrier layer is implemented as a single layer of a non-transparent polymer material and is so designed that it can adhere to a motor vehicle glass surface on its printed side and without any intermediate adhesive and/or adhesive material. The object is further achieved by the motor vehicle information system with a local data processing and printing device, which for the manufacture of the motor vehicle behind-glass adhesive label is designed with specific motor vehicle data present in the data processing device, wherein the local data processing and printing device is linked with a server unit via a data transfer network, which is designed for purposes of introducing at least a part of the specific motor vehicle data to the local data processing and printing device as a response to a requirements signal as well as for the provision of specific motor vehicle additional data as a response to an identification and/or requirements information item.

In an advantageous manner in accordance with the invention the carrier layer for the items of information according to the invention is firstly implemented in terms of one layer of a non-transparent, directly printable polymer material. Thus ensues advantageously the possibility of applying the printed image with the various regulated items of information directly onto the polymer material, and in fact such that the latter in the mounted state can then adhere to the glass surface, and in fact advantageously according to the invention without any intermediate adhesive and/or glued material.

By means of these measures in accordance with the invention the tasks underlying the invention are advantageously solved. Firstly the polymer material (non-transparent, thus forming good artwork with excellent contrast) can simply be printed with current printing devices, such as laser printing, wherein further preferred this can take place in a single printing process (printing pass) on an unprinted carrier material. This lowers the amount of manipulation effort and reduces the occurrence of errors.

The advantageous feature of the polymer material, to adhere without any intermediate adhesive or glue material on a glass surface (inner surface of a motor vehicle screen), leads to the fact that the adhesive label can not only be manipulated into position extremely simply, will but can also be removed without any residues in this most simple of configurations. Since moreover the adhesive label is not damaged when removed it can be reused without any problems, for instance at another location on the vehicle or in repeated application at the same location.

According to one preferred form of embodiment the invention includes the option of attaching the carrier layer completely and without any intermediate medium, wherein for this purpose a plastic film is selected in a particularly suitable manner that electrostatically adheres to a (dry) glass inner surface. In the same manner the invention includes the option of effecting a simple, bubble-free attachment using a thin water and/or tenside film (simply applicable, for instance, by means of a spray bottle or similar), in order to attach the single layer adhesive label (optionally also made from another adhesive plastic) to the screen.

It is particularly preferred within the framework of the invention for the polymer material of the carrier layer to use a polypropylene and/or polyvinyl chloride sheet, wherein the term “single layer” within the framework of the invention signifies that in the mounted state one is simply dealing with one sheet or one layer (however the option is not excluded, possibly for ease of printability of the polymer material that this layer is held before or during printing on a carrier layer, which however is removed before application, or in the mounted state).

It has been shown to be particularly beneficial in the implementation of the invention to select the mass per unit area of the polymer material in the range between 40 and 120 g/m², and further preferred in the range between 50 and 65 g/m², wherein this leads, for instance, for the preferred polypropylene material to be selected, to a layer thickness in the range between 50 and 90 μm, in particular in the range between 70 and 80 μm.

While in principle the configuration of the edge length of the preferred rectangular-shaped adhesive label is determined within the framework of the legal or administrative guidelines, use of a typical rectangular dimension of A3 format/Double Letter of 17 in×11 in, (431.8 mm×279.4 mm) has proved itself in practice.

In terms of content it is beneficial and preferred to print and arrange the items of information in accordance with the legal requirements, wherein in a further preferred manner the present invention also allows for multicolour printing and correspondingly a multicolour configuration of the adhesive label.

In a particularly favourable further development of the invention the motor vehicle behind-glass adhesive label can be considered as a part of a motor vehicle information system, wherein the adhesive label, in addition to its visually readable items of information, also has in particular at least one data and/or code pattern, for instance in the form of a barcode pattern, which can be suitably recorded optically, electronically or digitally. Within the framework of a preferred further development this provides the option of introducing and linking additional data relating to the vehicle and/or interested parties, which for example are available on a network and in conjunction with the data already contained on the adhesive label enable additional services or benefits to the customer to be maximised. For example, reference can simply be made to the option that a user, who is standing in front of the vehicle as an observer and studying the adhesive label from outside through a vehicle screen, using digital camera functionality and a mobile telephone to photograph the barcode pattern can identify the actual vehicle that is being studied, introduce via an electronic data transfer network (for example the public internet) additional data concerning the vehicle (for example information concerning other owners, additional information concerning the vehicle or similar) and with the aid of his own data in fact (e.g. his own finance information and credit rating data) is even already in a position to plan an actual individual credit finance scheme for this vehicle. Technically this is made possible in that the in the manner described digitally-optically scannable coding creates the link to additional net-based information with the aid of common (e.g. portable) Internet clients and at the same time makes possible a link with the data already contained on the adhesive label or coded into the barcode pattern.

Additionally the motor vehicle behind-glass adhesive label makes possible additional functionality by means of (plane, also printable) electronic components and surfaces. Thus a flat LED (OLED) display region can, e.g., be provided, on part of the surface to show variable or moving images, additionally or alternatively RFID antenna regions for HF communication with a user unit can be present, as can photovoltaic regions to provide a power supply to additional electronic components on the behind-glass adhesive label, such as the display cited, or an RFID unit.

As a result the present invention thus not only enables in everyday practice and for a large number of motor vehicles a noticeable reduction in effort in the manipulation of the otherwise laborious identification and display of motor vehicles as legally regulated, it also enables added value in an extremely simple manner by the systematic linking and introduction of external (net-based) information, which not only provides immediate added value for the motor vehicle trader as user, but also offers to the customer the immediate option of additional functionality-enhancing information processing.

### BRIEF DESCRIPTION OF THE DRAWINGS

Further advantages, features, and details of the invention ensue from the following description of preferred examples of embodiment and also from the drawings; these show in:

FIG. 1: a schematic cross-section of the motor vehicle behind-glass adhesive sticker with a first preferred form of embodiment of the present invention;

FIG. 2: a second form of embodiment of the invention analogous to the representation of FIG. 1;

FIG. 3: a schematic block diagram to clarify various system components of the motor vehicle information system provided according to a further development within the framework of the invention;

FIG. 4: a schematic view of a behind-glass adhesive label, with the typical items of information regulated by the legal requirements;

FIG. 5: a sectional view through the behind-glass adhesive label according to the prior art;

FIG. 6: a representation of a behind-glass adhesive label installed in the vehicle, and

FIG. 7: a visualisation of an optical recording of a code region of the behind-glass adhesive label with a portable means of data communication according to a further form of embodiment of the invention.

### DETAILED DESCRIPTION

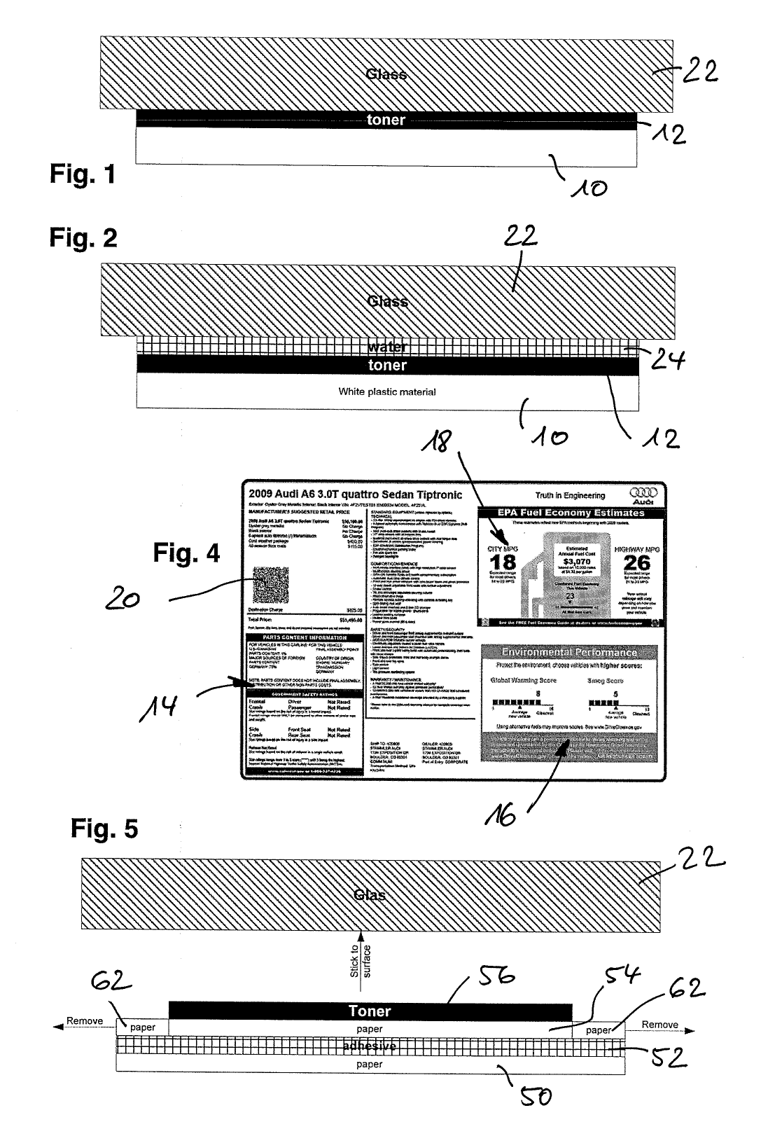

FIG. 1 clarifies the structural principles of a first example of embodiment (best mode) of the present invention. In the simplest example of embodiment a carrier layer implemented from a solid white-coloured polypropylene film 10 of a thickness of 76 μm has single-sided printing (“toner”) 12, which has a multiplicity of items of information for purposes of implementing the print image of a so-called Monroney adhesive label (FIG. 4); these include vehicle-specific information according to information block 14, environmental sustainability items of information according to information block 16, and fuel consumption items of information according to information block 18, as they are generated in the representation of FIG. 4 in the print image. In addition the print image contains a code region 20, as included in FIG. 4 as a two-dimensional barcode.

This print image is applied by means of a conventional laser printer or inkjet printer onto the film 10, wherein for this purpose the film itself can be supported on a support or carrier paper—not shown—(which is then later removed for the application).

The carrier unit with mounted print image 12 is then applied to a glass surface of a vehicle screen in the manner shown in FIG. 1 as a behind-glass adhesive label, wherein the example of embodiment of FIG. 1 enables the adherence of the arrangement on a dry screen surface by means of electrostatics. In other words, the attachment of the unit 10, 12 to the glass screen 22 takes place by means of simple application and firm pressure without the use of any kind of adhesive agent or similar substance, if necessary with the removal of air bubbles.

The longitudinal schematic section of FIG. 2, analogous to FIG. 1, clarifies a second example of embodiment of the present invention. The adhesive effect is here strengthened by or based on an additional water film 24 deposited by means of a spray nozzle, which is applied onto the printed film material 10 directly before the application onto the glass surface 22. A procedure of this kind and the use of water (if necessary by means of a tenside or similar cleaning agent in the water) brings with it advantages with regard to an (air) bubble-free application and in a similar manner to the purely dry application of FIG. 1 enables a practically residue-free removal of the film after use.

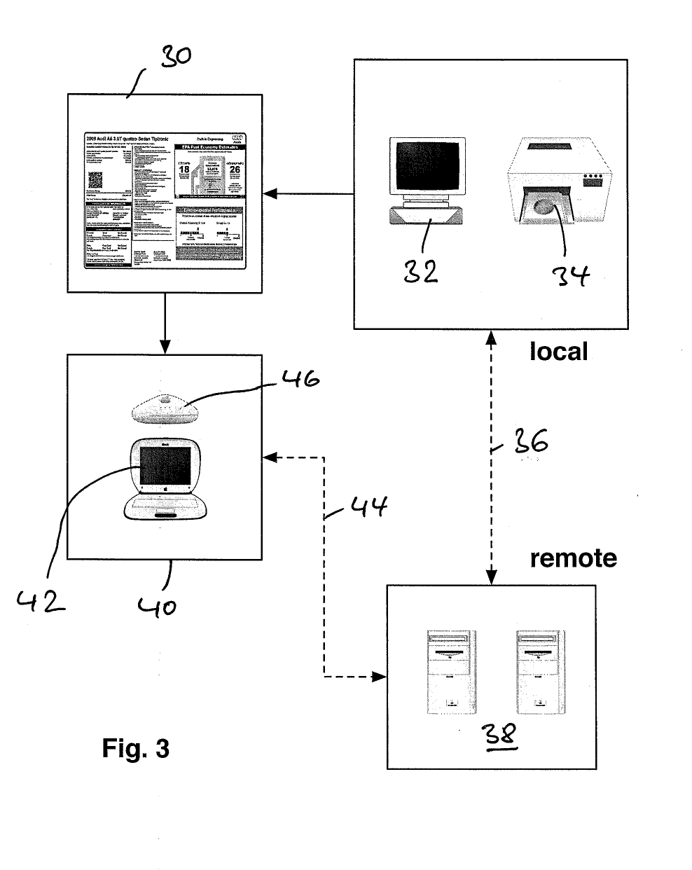

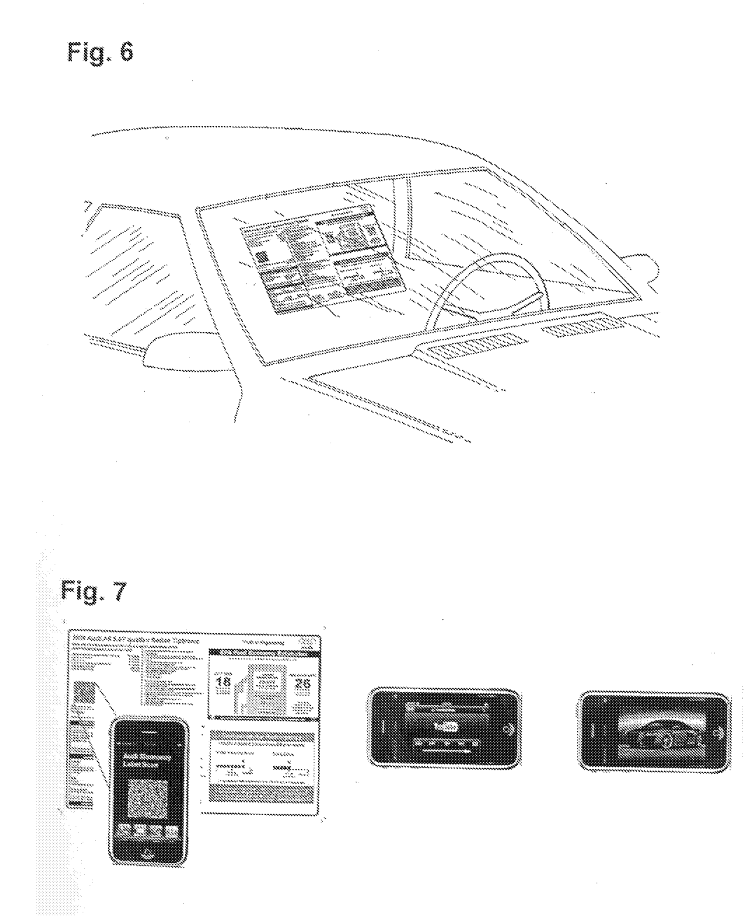

FIG. 3 clarifies in the schematic block view the further development of the motor vehicle behind-glass adhesive label of FIGS. 1, 2, 4 as part of a networked system. Here the schematic border 30 represents a motor vehicle, onto at least one screen of which the Monroney adhesive label of FIG. 4, manufactured as a behind-glass adhesive label in one of the ways described above, is attached. To be more precise the manufacture of the behind-glass adhesive label by means of a one-pass print process using a local data processing unit 32 with attached printer 34 has taken place at a typical user site, e.g. at the vehicle manufacturer's site, or in the port in the case of imported vehicles, or at the site of a motor vehicle dealer when manufacturing a substitute “local” adhesive label.

The data processing unit 32 is “remotely” linked, cf. the dashed line 36, via a (preferred public) data transfer network, for instance the Internet, with a server unit, symbolised by the arrangement 38 of servers, which provides various items of information to the local data processing unit 32, in particular also for purposes of updating and/or organisation of the content of the adhesive label (FIG. 4). Thus, for instance, the user at the site locally has the option, to access various parameters, technical data or similar for each vehicle that has to be identified, via the network 36 and the server unit 38, and thus whilst minimising the complexity of local data storage (which in the simplest case is just a buffering of externally received data) to generate a data set for the adhesive label that is always up-to-date.

Additional user added value exists within the framework of the invention in that an interested party (box 40) possessing a typical mobile data processing device by taking photographs of the code field 20 (FIG. 4) or by using other forms of optical data recording and data processing can record in a simple manner the data for the vehicle that he is studying—through the screen—and the portable data processing unit 42, linked via a data line 44 to the central server unit (ideally again using the Internet) can then effect additional data links or similar. Thus it is, for example, possible, having regard to an individual finance or credit profile for a user 40, to work out on the spot a firm finance quotation for each vehicle studied. In a supplementary or alternative manner the user has the option, to introduce additional information regarding the vehicle that he has identified (a camera unit is shown schematically), such as audiovisual information, which cannot as such be stored locally for reasons of capacity, supplementary or alternative items of dynamic or communications information, such as, for instance, are obtainable within the framework of web services.

In the manner shown the present invention can be integrated into a system, which not only significantly increases the ability to generate and use adhesive labels for conventional motor vehicle display purposes, but also allows further development of this technology through to an integrated communications system, which creates significant added value both for a sales person/vendor (as the user of the display) and also for the person targeted (as a possible customer).

The present invention is not limited to the example of embodiment described. Thus, for example, the invention also includes the option of implementing the code pattern on the behind-glass adhesive label in another manner, e.g. by means of an RFID structure or similar, likewise the creation of other options to integrate additional local information or to information that can be remotely introduced into the system.

Also the print design is not limited to a black and white design, but can be suitably multi-coloured; in the same manner as the single-layer carrier material, which is preferably configured to be opaque/non-transparent and solid-coloured in white, can be provided in another colour, or by means of other elasticity, surface and adhesion parameters.

1. A motor vehicle behind-glass adhesive label with printing having a multiplicity of items of information, which is applied onto a flexible carrier layer by means of laser, offset and/or digital printing, the improvement comprising a carrier layer is implemented as a single layer of a non-transparent polymer material and is so designed that it can adhere to a motor vehicle glass surface on its printed side and without any intermediate adhesive and/or adhesive material.

2. The adhesive label according to claim 1, wherein the polymer material has polypropylene, polyvinyl chloride and/or gecko tape polymer material.

3. The adhesive label according to claim 1, wherein the single-layer carrier layer has a mass per unit area in the range between 40 and 120 g/m².

4. The adhesive label according to claim 1, wherein the single-layer carrier layer has a mass per unit area in the range between 50 and 65 g/m².

5. The adhesive label according to claim 1, wherein the single-layer carrier layer has a thickness in the range between 50 and 90 μm.

6. The adhesive label according to claim 1, wherein the single-layer carrier layer has a thickness in the range between 70 and 80 μm.

7. The adhesive label according to claim 1, wherein the carrier layer is designed such that in the printed state it adheres dry on the glass surface by means of electrostatic adhesion or Van der Waals forces, without a fluid or paste substance being applied between carrier layer and glass surface.

8. The adhesive label according to claim 1, wherein the carrier layer is designed such that it adheres to the glass surface by means of a water and/or tenside film.

9. The adhesive label according to claim 1, wherein the carrier layer is designed as a rectangular shape in the A3/Double Letter range of formats, wherein a first longer edge has an edge in the range of lengths between 16.5 to 19 and a second short edge has an edge in the range of lengths between 11 to 13.

10. The adhesive label according to claim 1, wherein the printing is applied by means of a printing process onto an unprinted carrier layer.

11. The adhesive label according to claim 1, wherein the items of information have an item specific to vehicle type, an environmental sustainability item, together with a fuel consumption item, and these items of information are provided on the carrier layer distributed in a planar manner.

12. The adhesive label according to claim 1, wherein the items of information have at least one coding and/or barcode pattern, that is designed such that by means of digital image recording means it can be recorded through a motor vehicle screen and prepared for further digital processing.

13. The adhesive label according to claim 1, including a planar electronic component on the carrier layer, wherein the electronic component can have a flat display, a flat high frequency antenna and/or flat means for electronic energy generation.

14. A motor vehicle information system with a local data processing and printing device, which for the manufacture of the motor vehicle behind-glass adhesive label according to claim 1 is designed with specific motor vehicle data present in the data processing device, wherein the local data processing and printing device is linked with a server unit via a data transfer network, which is designed for purposes of introducing at least a part of the specific motor vehicle data to the local data processing and printing device as a response to a requirements signal as well as for the provision of specific motor vehicle additional data as a response to an identification and/or requirements information item.

15. A system according to claim 14, wherein the identification or requirements information on a data and/or code section of the motor vehicle behind-glass adhesive label is contained as an electronically scannable and/or recordable print image.

16. The system according to claim 14, including an additional flat electronic component on the motor vehicle behind-glass adhesive label, which has a display, an HF antenna and/or an electrical power supply.
